(19) United States
(12) Patent Application Publication
(10) Pub. No.: US 2024/0422005 A1
(43) Pub. Date: Dec. 19, 2024

(54) Accelerating Quantum-Resistant, Cryptographic Hash-Based Signature Computations

(71) Applicant: Google LLC, Mountain View, CA (US)

(72) Inventors: Vadim Sukhomlinov, Santa Clara, CA (US); Miguel Angel Osorio Lozano, El Dorado Hills, CA (US); Christopher J. Frantz, Sunnyvale, CA (US)

(73) Assignee: Google LLC, Mountain View, CA (US)

(21) Appl. No.: 18/699,555

(22) PCT Filed: Oct. 11, 2021
(86) PCT No.: PCT/US2021/054431

§ 371 Date: Apr. 8, 2024

(51) Int. Cl. H04L 9/32

(52) U.S. Cl. CPC H04L 9/3236

(57) ABSTRACT

This document describes techniques and apparatuses directed at accelerating quantum-resistant, cryptographic hash-based signature computations. Upon receipt of an input message, one or more processors implements a hash manager. The hash manager is configured to initialize variables, load the input message and initialized variables into an input buffer, and execute a hash-based signature computation. The hash-based signature computation is repeated for a predetermined number of iterations with each iteration involving loading at least a portion of a digest message directly into a configurable position in the input buffer. In so doing, this method of iterative hash computation bypasses memory copies and bus latencies, accelerating quantum-resistant, cryptographic hash-based signature computations.

### BACKGROUND

As a result of the ever-increasing computerization of society, and the associated Internet-of-Things (IoT) expansion, the world is increasingly susceptible to a variety of cyberattacks. These cyberattacks can severely impact not only one's information security, but also one's physical safety. To thwart cyberattacks, numerous security measures are implemented on computing devices to prevent unauthorized access to and manipulation of device data and communications. Some of these security measures employ digital signature schemes, often based on asymmetric cryptographic algorithms including Rivest-Shamir-Adleman (RSA) and Elliptic Curve Digital Signature Algorithm (ECDSA). These asymmetric cryptographic algorithms base an aspect of their security on the inordinate amount of time required for decoding using classical computing techniques.

Advances in quantum computing, however, may render these commonly used asymmetric cryptographic algorithms vulnerable to cyberattacks. This is due to quantum computers being capable of computing exponentially faster than classical computers. For example, quantum-computing algorithms, such as Shor's algorithm and Grover's algorithm, may provide a quadratic speedup for brute-force searches. In response, cryptographic algorithms believed to be secure against cyberattacks performed by quantum computers have been developed. However, many of these quantum-resistant, cryptographic algorithms take an excessive amount of time to compute, making most implementations unsuitable for many applications, such as on constrained devices.

### SUMMARY

This document describes techniques and apparatuses directed at accelerating quantum-resistant, cryptographic hash-based signature computations. Upon receipt of an input message, one or more processors implement a hash manager. The hash manager is configured to initialize variables, load the input message and initialized variables into an input buffer, and execute a hash-based signature computation. The hash-based signature computation is repeated for a predetermined number of iterations with each iteration involving loading at least a portion of a digest message directly into a configurable position in the input buffer. In so doing, this method of iterative hash computation bypasses memory copies and bus latencies, accelerating quantum-resistant, cryptographic hash-based signature computations.

This Summary is provided to introduce simplified concepts for accelerating quantum-resistant, cryptographic hash-based signature computations, which is further described below in the Detailed Description and is illustrated in the Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of accelerating quantum-resistant, cryptographic hash-based signature computations are described in this document with reference to the following drawings:

FIG. 1 illustrates an example operating environment that includes an example computing device, which is capable of implementing cryptographic techniques and other security functions in accordance with one or more aspects disclosed in this document;

FIG. 2 illustrates one example integrated circuit component implemented as a cryptographic coprocessor;

FIG. 3 illustrates operations of a hash manager when executed by a processor;

FIG. 4 illustrates an example method, implemented by a hash manager, to accelerate iterative hash-based signature computations;

FIG. 5 illustrates an example method, implemented by a hash manager, to accelerate iterative hash-based signature computations by directly loading at least a portion of a digest message into a configurable position in the input buffer and performing a hash computation for a predetermined number of iterations; and

FIG. 6 illustrates an integrated circuit component implemented as a System-on-Chip (SoC) that can implement various aspects of accelerating iterative hash-based signature computations.

The use of same numbers in different instances may indicate similar features or components.

### DETAILED DESCRIPTION

### Overview

Computing devices often include an integrated circuit with security circuitry and software to provide a measure of protection against defects, attacks, and other potentially compromising events. The security circuitry and software may implement a number of security paradigms, such as those adhering to guidelines including those outlined in the National Institute of Standards and Technology (NIST) and/or Public-Key Cryptography Standards (PKCS). For example, during firmware updates, the security circuitry and software, adhering to PKCS standards, may verify the authenticity and integrity of the data the computing device receives and executes using digital signatures (e.g., cryptographic signatures). A digital signature scheme is a mathematical scheme employed to validate a digital message or document. A valid digital signature gives a recipient confidence to know that the message was generated by a known sender (“authenticity”) and that it was not manipulated sometime during transmission (“integrity”). In so doing, the security circuitry and software reduce the opportunity for information to be inadvertently exposed or for some function to be used in a harmful or otherwise unauthorized manner.

In today's computing environment, bad actors can uncover encrypted data or attack computing devices at a myriad of levels using a multitude of attack vectors. Recent development in quantum computing, for instance, greatly diminishes the protection many of these security paradigms afford, since they presuppose attacks using classical computing techniques. As a result, an attacker using quantum computing may be able to gain unauthorized access to, or control of, a computing device or device data by a variety of cyberattacks. For example, a computing device may cryptographically encrypt sensitive data and transmit the encrypted data over a network. An attacker, connected to the network, may acquire the encrypted data and decrypt it using quantum computing. In another example, an attacker may be able to inject malware into firmware updates for a computing device, such as a Wi-Fi® router or an IoT device. If the attacker successfully installs a fraudulent segment of code into the computing device without the computing device verifying the authenticity or integrity of the firmware update, the unauthorized reconfiguration of the computing device can uncover confidential or sensitive data, or even cause the device to operate unintendedly, posing a potential safety risk to human operators.

To attempt to counter these potential attacks on computing devices and secure data transmission, this disclosure describes integrating quantum-resistant security paradigms. One such software-based security paradigm theorized to be resistant to quantum computer cyberattacks is iterative hash-based signature computations (“hash computations”). Hash-based signatures schemes combine a one-time signature scheme (e.g., Lamport one-time signature scheme) with a Merkle tree structure (e.g., a technique to combine many keys within a single, larger structure). One-time signature schemes are built from any cryptographically secure one-way function, such as a cryptographic hash function (e.g., a hashing algorithm, a trap function, an irreversible function).

A cryptographic hash function is a mathematical function that maps an arbitrary-length input data stream (“input message”) to a fixed-length output (“digest message”). An iterative hash computation includes repeating the cryptographic hash function for an iterative number of times. Due to this method of iterative hash computation, any alterations to the input message will, with very high probability, completely change the message digest (e.g., the avalanche effect). Cryptographic hash functions are, therefore, effective in secure and efficient digital information transmission and processing.

Approaches to implement quantum-resistant, software-based paradigms on security circuitry that employ hardware architectures for iterative hash computations, however, are not well-suited for time-sensitive, constrained devices. For example, while performing iterative hash computations with conventional hardware architectures, a cryptographic processor may execute numerous bus transactions during a single iteration to transmit and retrieve results. Further, the cryptographic processor may reprogram a hash engine and load a new input for each iteration. Consequently, the time required to perform a single hash computation in an iterative hash computation scheme is often double the amount of time to perform a single hash computation in an un-iterative hash computation scheme. Executing a computationally expensive algorithm, such as a hashing algorithm while performing each of the aforementioned operations each iteration, significantly slows processing and is also power-consuming for constrained devices.

In contrast, this document describes techniques and apparatuses directed at accelerating quantum-resistant, cryptographic hash-based signature computations by loading at least a portion of a digest message directly into a configurable position in an input buffer. In so doing, this method of iterative hash computation bypasses memory copies and bus latencies, accelerating quantum-resistant, cryptographic hash-based signature computations.

The following discussion describes an operating environment, techniques that may be employed in the operating environment, an example method, and a System-on-Chip (SoC) in which components of the operating environment may be embodied. In the context of the present disclosure, reference is made to the operating environment by way of example only.

### Operating Environment

The following discussion describes an operating environment, techniques that may be employed in the operating environment, and various devices or systems in which components of the operating environment can be embodied. In the context of the present disclosure, reference is made to the operating environment by way of example only.

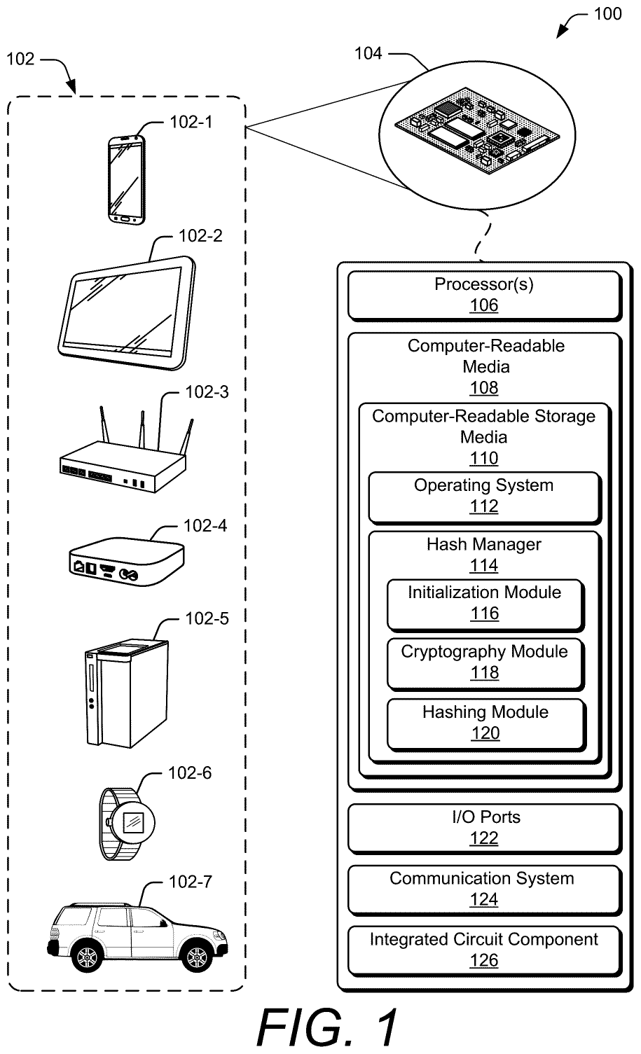

FIG. 1 illustrates an example operating environment 100 that includes an example computing device 102, which is capable of implementing cryptographic techniques and other security functions. Examples of the computing device 102 include a smart-phone 102-1, a tablet computer 102-2, a wireless router 102-3, a set-top box 102-4, a network-attached storage (NAS) device 102-5, a wearable computing device 102-6 (e.g., computerized watch), and an automobile 102-7. Although not shown, the computing device 102 may also be implemented as any of a mobile station (e.g., fixed- or mobile-STA), a mobile communication device, a client device, a home automation and control system, an entertainment system, a gaming console, a personal media device, a health monitoring device, a drone, a camera, an Internet home appliance capable of wireless Internet access and browsing, an IoT device, security systems, and the like. Note that the electronic device 102 can be wearable, non-wearable but mobile, or relatively immobile (e.g., desktops, appliances). Note also that the electronic device 102 can be used with, or embedded within, many electronic devices 102 or peripherals, such as in automobiles or as an attachment to a laptop computer. The computing device 102 may implement cryptography or security functions for any suitable purpose, such as to enable security functionalities of a particular type of computing device, enable secure network access, encrypt data for storage, verify software signatures, authenticate users or other devices, sign electronic files or documents, and the like. The computing device 102 may provide other functions or include components or interfaces omitted from FIG. 1 for the sake of clarity or visual brevity.

The computing device 102 includes a printed circuit board assembly 104 (PCBA) 104 on which components and interconnects of the computing device are embodied. Alternately or additionally, components of the computing device 102 can be embodied on other substrates, such as flexible circuit material or other insulative material. Although not shown, the computing device 102 may also include a housing, various human-input devices, a display, a battery pack, antennas, and the like. Generally, electrical components and electromechanical components of the computing device 102 are assembled onto a printed circuit board (PCB) to form the PCBA 104. Various components of the PCBA 104 (e.g., processors and memories) are then programmed and tested to verify the correct function of the PCBA 104. The PCBA 104 is connected to or assembled with other parts of the computing device 102 into a housing.

As illustrated, the PCBA 104 includes one or more processors 106 and computer-readable media 108. The processor(s) 106 may be any suitable single-core or multi-core processor (e.g., an application processor (AP), a digital-signal processor (DSP), a central processing unit (CPU), graphics processing unit (GPU)). The processor(s) 106 may be configured to execute instructions or commands stored within the computer-readable media 110 to implement an operating system 112 and a hash manager 114 having an initialization module 116, a Cryptography Module 118, and/or a hashing module 120 which are stored within computer-readable storage media 110. The computer-readable storage media 110 may include one or more non-transitory storage devices such as a random access memory (RAM, dynamic RAM (DRAM), non-volatile RAM (NVRAM), or static RAM (SRAM)), read-only memory (ROM), or flash memory), hard drive, SSD, or any type of media suitable for storing electronic instructions, each coupled with a computer system bus. The term “coupled” may refer to two or more elements that are in direct contact (physically, electrically, magnetically, optically, etc.) or to two or more elements that are not in direct contact with each other, but still cooperate and/or interact with each other.

The PCBA 104 may also include I/O ports 122 and communication systems 124. The I/O ports 122 allow the computing device 102 to interact with other devices or users. The I/O ports 122 may include any combination of internal or external ports, such as USB ports, audio ports, Serial ATA (SATA) ports, PCI-express based ports or card-slots, secure digital input/output (SDIO) slots, and/or other legacy ports. Various peripherals may be operatively coupled with the I/O ports 122, such as human-input devices (HIDs), external computer-readable storage media, or other peripherals.

The communication systems 124 enable communication of device data, such as received data, transmitted data, or other information as described herein, and may provide connectivity to one or more networks and other devices connected therewith. Example communication systems include NFC transceivers, WPAN radios compliant with various IEEE 802.15 (Bluetooth®) standards, WLAN radios compliant with any of the various IEEE 802.11 (WiFi®) standards, WWAN (3GPP-compliant) radios for cellular telephony, wireless metropolitan area network (WMAN) radios compliant with various IEEE 802.16 (WiMAX®) standards, infrared (IR) transceivers compliant with an Infrared Data Association (IrDA) protocol, and wired local area network (LAN) Ethernet transceivers. Device data communicated over communication systems 124 may be packetized or framed depending on a communication protocol or standard by which the computing device 102 is communicating. The communication systems 124 may include wired interfaces, such as Ethernet or fiber-optic interfaces for communication over a local network, intranet, or the Internet. Alternatively or additionally, the communication systems 124 may include wireless interfaces that facilitate communication over wireless networks, such as wireless LANs, cellular networks, or WPANs.

Although not shown, the computing device 102 can also include a system bus, interconnect, crossbar, or data transfer system that couples the various components within the device. A system bus or interconnect can include any one or combination of different bus structures, such as a memory bus or memory controller, a peripheral bus, a universal serial bus, and/or a processor or local bus that utilizes any of a variety of bus architectures.

The PCBA 104 further includes an integrated circuit component 126. In various implementations, the integrated circuit component 126 may be a secure, root of trust (RoT) application-specific integrated circuit (ASIC) component, including a cryptographic coprocessor, processor, microcontroller, microprocessor, System-on-Chip (SoC), or the like operably interfaced to the processor(s) 106 (e.g., a host processor). The integrated circuit component 126 (e.g., a hash engine, a hash accelerator) may be implemented as embedded system security, having the computational capacity to perform calculations required to verify the authenticity and integrity of downloaded software. The integrated circuit component 126 may be communicatively coupled, through private interfaces, to a secure, non-volatile computer-readable storage media 108. In some implementations, the integrated circuit component 126 may include a hash engine (e.g., a processor configured to execute a hash function). In another implementation, the integrated circuit component 126 may be a hash engine.

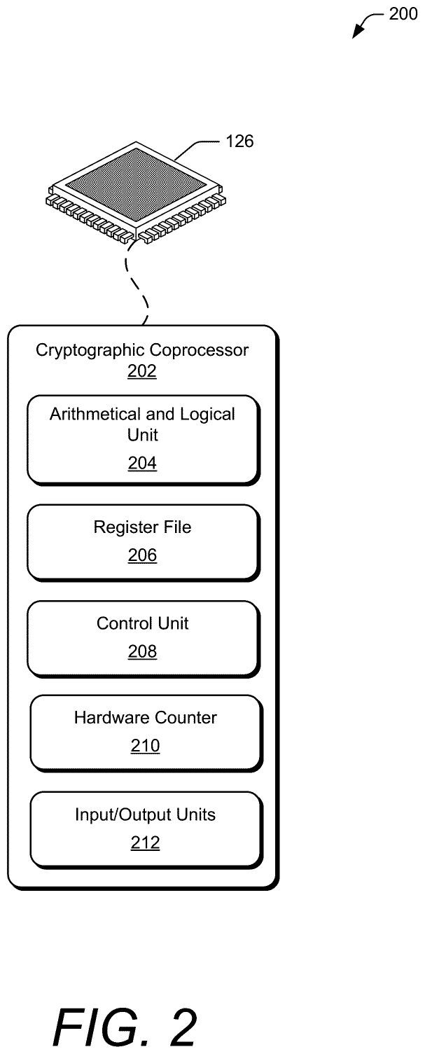

In more detail, consider one example of the integrated circuit component 126 implemented as a cryptographic coprocessor 202, shown in FIG. 2. This is but one example, as the integrated circuit component 126 may be implemented as a cryptographic microprocessor, microcontroller, SoC, or the like. In this implementation, the cryptographic coprocessor 202 may operate as a hash engine. In other implementations, the integrated circuit component 126 may be, for example, an SoC having components including a processor operating as a hash engine.

As illustrated in FIG. 2, the cryptographic coprocessor 202 may include an arithmetical and logical unit 204 (ALU 204), a register file 206, a control unit 208, a hardware counter 210, and input/output (I/O) units 212. The ALU 204 may be configured to perform arithmetic and logical operations on received data. The register file 206 may be an array of processor registers (e.g., control registers), serving as high-speed, semi-transient memory configured for quick data access during program or function processing. The registers may be tightly coupled to the ALU 204 or other execution unit to enable the cryptographic coprocessor 202 to quickly access the working data. To further facilitate access to the data, the register file may include multiple read ports or multiple write ports to enable the ALU 204 and/or execution unit to contemporaneously retrieve multiple operands in a single cycle. The cryptographic coprocessor 202, or ALU 204 and execution unit thereof, may access the register file using a register address space that is separate from the system address space. In some cases, registers are numbered for access via a register address space. The register files may be formed from flip-flops to accelerate reading and writing bits of the data. The control unit 208 may be configured to control the flow of data throughout the system(s). The hardware counter 210 (e.g., a hardware performance counter, a processor performance counter) may count events, transactions, or iterations that take place at the processor level. For example, the hardware counter 210 may count the number of cycles and instructions that a program executed. The I/O units 212 may include ports operably interfaced with other components of the device.

### Techniques for Accelerating Hash Computations

In an aspect, the computing device 102 may implement steps for verification of a hash-based signature. For example, the processor(s) 106 may receive an input message (e.g., a firmware update, a configuration data file), as well as a digital signature signed with the same private key. In order to validate the integrity and authenticity of the input message, an iterative hash computation to generate a digest message of the input message may be performed. In another aspect, the computing device 102 may implement steps for public key computation and public key signing.

In aspects, upon receipt of the input message, the processor(s) 106, operably connected to the computer-readable media 108 and the integrated circuit component 126, may run a fetch/execute cycle, cycling through instructions of the hash manager 114 stored in the computer-readable media 108. In another implementation, upon receipt of the input message, the processor(s) 106 may load the input message to the integrated circuit component 126 and instruct the integrated circuit component 126 to run a fetch/execute cycle, cycling through instructions of the hash manager 114 stored in the computer-readable media 108.

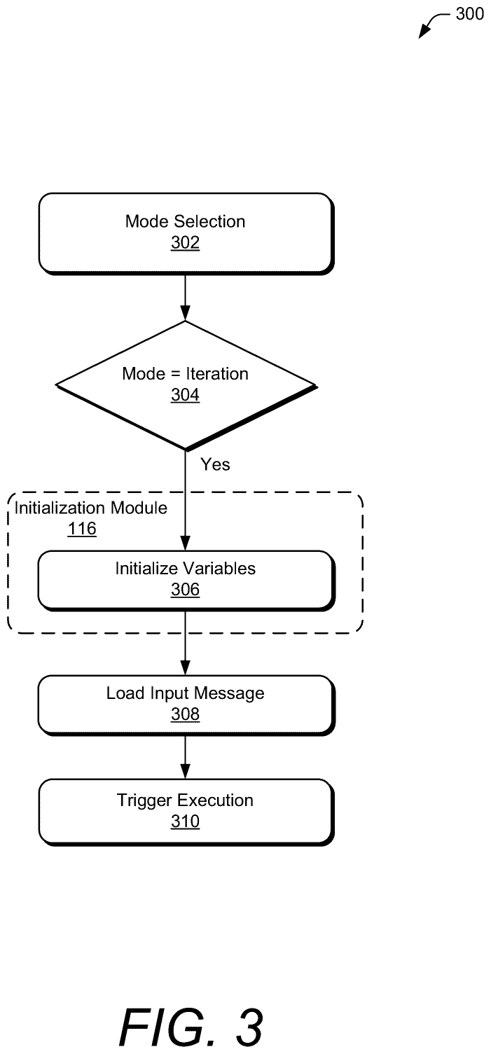

FIG. 3 illustrates operations of a hash manager 114 (not shown) when executed by a processor (e.g., processor(s) 106). In an aspect, the hash manager 114 selects a mode 302. The mode selection 302 may be a binary decision, including a mode configured for a single hash computation and a mode configured for an iterative hash computation. If the selected mode 302 indicates an iterative hash computation 304, then the hash manager 114 may execute the initialization module 116. The initialization module 116 may initialize variables 306 for the iterative hash computation. For example, the processor may program values for the following variables: input message length, copy offset, copy length, update offset, and update length. The values of these variables may be used to identify a byte index within an input message. The processor may further program a desirable number of iterations to perform a hash computation and assign this value to a variable referred to herein as iteration counter. For example, the processor may assign the value of 255 to the iteration counter variable, thereby programing a hash computation to execute as many as 256 times. The values of the variables for the iterative hash computation may be loaded into configurable positions within an input buffer (e.g., the register file of the cryptographic coprocessor 202).

Next, or in parallel to the operations of the initialization module 116, the hash manager 114 may load the input message 308 into a configurable position in the input buffer of the integrated circuit component 126. Once the input message and the variables for the iterative hash computation have been loaded, the hash manager 114 may trigger execution 310 of the iterative hash computation on the integrated circuit component 126.

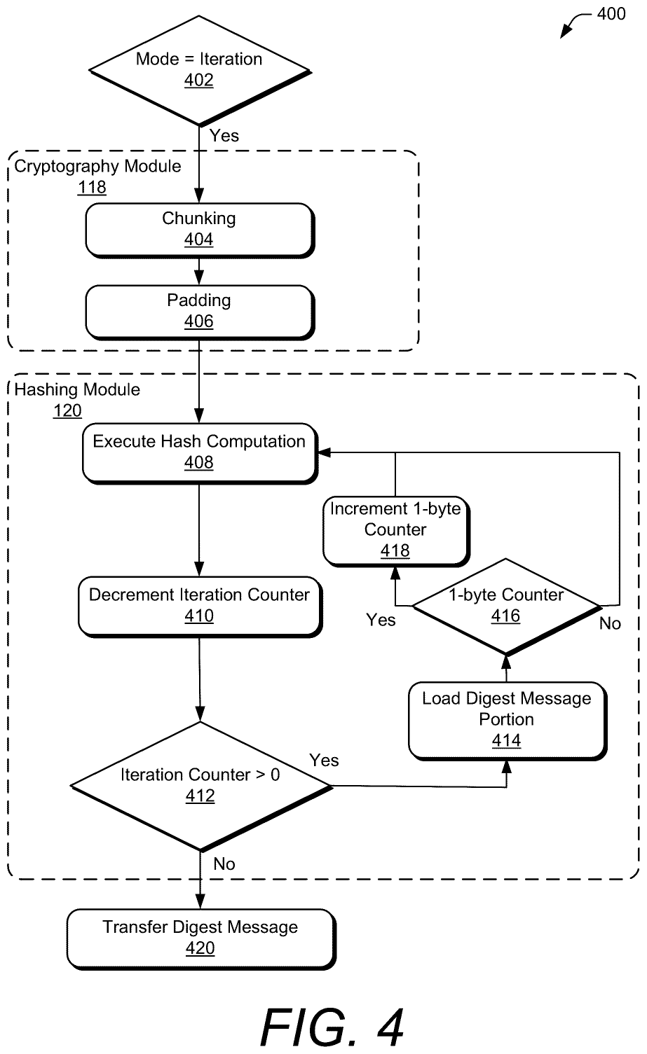

FIG. 4 illustrates example method 400, implemented by a hash manager 114, to accelerate iterative hash computations. In an aspect, the hash manager 114 (not shown) may determine a selected mode. If the selected mode indicates an iterative hash computation, then the hash manager 114 may execute the cryptography module 118. The cryptography module 118 may implement various cryptographic techniques, such as breaking the input message into n message blocks (“chunking”) 404 or adding data to the beginning, middle, or end of an input message (“padding”) 406. In some implementations, the cryptography module 118 may incorporate random data into an input message (“salting”). In another implementation, some or all operations of the cryptography module 118 may be included in the hashing module 120.

Further to the above descriptions, the input message may be a bit-string (e.g., 256 bits, 512 bits) including the concatenation of substrings, such as a prefix, a suffix, a secret seed, and/or a counter, of various lengths, in various orders, and at varying index locations within the input message. In an implementation, the input message may be 55 bytes long, having a 22-byte prefix, a 1-byte counter, and a 32-byte secret seed. In this implementation, the 22-byte prefix may be padded data added to the beginning of the input message, the 1-byte counter may be a section of the input message wherein the hashing module 120 monotonically increases the value by 1-bit for an iteration, and the 32-byte secret seed may include bytes of the input message or bytes of a digest message. In implementations, the 1-byte counter may increase or decrease in a non-monotonic fashion. In still other implementations, the 1-byte counter may be initialized at a value configured for a use case, including hash-based signature verification or public key computation and signing.

The hash manager 114 may then execute the hashing module 120. The hashing module 120 may involve executing a hash computation 408, decrementing the iteration counter 410, determining if the iteration counter is greater than zero 412, loading at least a portion of a digest message 414 if the iteration counter is greater than zero, determining if a 1-byte counter exists 416 in the input message, and incrementing the 1-byte counter 418 if it exists. In more detail, the hash engine, using the input message as input, may execute a hash computation 408. The hash engine may execute a cryptographic hash function to generate a digest message. The hash engine may implement any cryptographic hash function, complying with a particular standard, such as SHA256. Depending on the cryptographic hash function utilized, the digest message may vary in length.

After, or in parallel to, executing the hash computation 408, the hashing module 120 may decrement the iteration counter 410 by one count value. If the iteration counter value is greater than zero 412, then the hashing module 116 may load at least a portion of the digest message directly into a configurable position in the input buffer 414. Next, or in parallel to loading at least a portion of the digest message, the hash manager 114 may determine if a 1-byte counter exists 416 in the input message. If the 1-byte counter does exist in the input message, the hashing module 120 can increment the 1-byte counter 418 by one count value. Once the 1-byte counter in the input message is incremented, then the hashing module 120 can continue, repeating operations of the hashing module 120 until the iteration counter count is no longer greater than zero. If the 1-byte counter does not exist in the input message, then the hashing module 120 can continue, repeating operations of the hashing module 120 until the iteration counter count is no longer greater than zero. When the iteration counter value is no longer greater than zero, the hashing module 120 may cease execution and the hash manager 114 may transfer the result of the iterative hash computation (e.g., the digest message) 420 to a processor (e.g., a Hash-Based Message Authentication Codes (HMAC) core, a host processor).

Directly loading at least a portion of the digest message into a configurable position in the input buffer for a predetermined number of iterations avoids bus latencies associated with bus transactions and utilizes quick-access memory, thereby accelerating hash computations. Further, at least a portion of the digest message can be loaded into a configurable position of the input buffer, updating the secret seed of a previous input message, and, as a result, enable the hash engine to execute without needing to be reprogrammed.

### Example Method

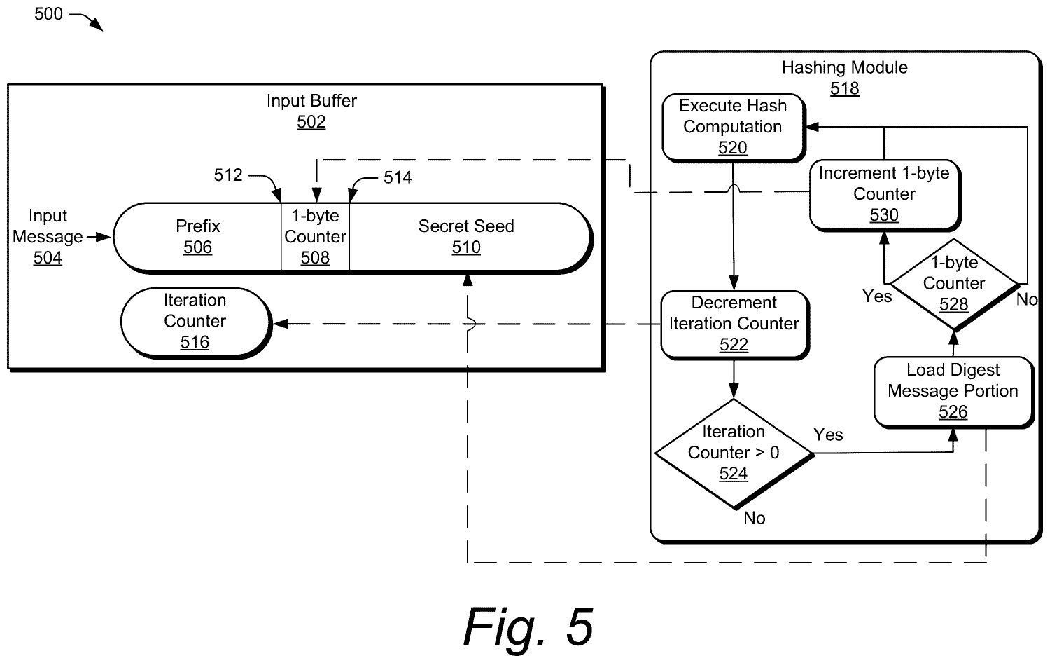

This section describes an example method to accelerate iterative hash computations. FIG. 5 illustrates example method 500, implemented by a hash manager (e.g., hash manager 114), to accelerate iterative hash computations by directly loading at least a portion of a digest message into a configurable position in an input buffer and performing a hash computation for a predetermined number of iterations. As illustrated, an input buffer 502 includes an input message 504, having a prefix 506, a 1-byte counter 508, and a secret seed 510. The prefix 506 may be, for example, 22 bytes long. The 1-byte counter may, for example, start at an 8-bit binary value equaling zero (e.g., 00000000 in binary). The secret seed 510 may be, for example, 32 bytes long. The input buffer 502 may further include variables initialized by an initialization module (not shown). An update offset 512 variable may be a 6- or 8-bit string equal to 22. A copy length 514 variable may be a 6- or 8-bit string equal to 23. A copy length (not shown) variable may be a 6- or 8-bit string equal to the digest message length. In an implementation, the copy length may be equal to at least a portion of the digest message length. An update length (not shown) may be a 6- or 8-bit string equal to the length of the 1-byte counter. Further, the input buffer may include an 8-bit iteration counter 516 variable. For example, the iteration counter may be initialized to a count value of 255 (e.g., 11111111 in binary). The iteration counter may determine the number of iterations a hash computation is repeated.

FIG. 5 further illustrates a hashing module 518. In an aspect, the hashing module 518 is implemented by a hash engine (not shown). For example, the hash engine may be a cryptographic coprocessor implementing the cryptographic hash function SHA256. The hash engine, using the input message as input, may perform an iterative hash computation. For example, the hashing module 518 may execute a hash computation 520, resulting in a digest message (not shown). Next, the hashing module 518 may decrement the iteration counter 522. For instance, the iteration counter 516 may be decremented to a count value of 254 (e.g., 11111110 in binary). Next, the hashing module 518 may determine if the iteration counter 516 value is greater than zero. If the iteration counter 516 value is not greater than zero, then the hashing module 518 may cease execution and a Hashing Manager (not shown) can transfer the digest message to a processor. If the iteration counter 516 value is greater than zero, then the hashing module 518 can load at least a portion of the digest message 526 to a configurable position in the input buffer 502. For example, the hash engine executing SHA256 may generate a 32-byte digest message. The hashing module 518 may load the bits of the digest message into the secret seed section of the input message, replacing an old secret seed. As a result, the input message is updated with at least a portion of the 32-byte digest message. Next, the hashing module 518 may determine if a 1-byte counter 528 exists in the input message 504. If the hashing module 518 determines a 1-byte counter 508 does exist in the input message, then the hashing module may increment the 1-byte counter 530. For example, the 1-byte counter 508 may increment to a count value of one (e.g., 00000001 in binary). In so doing, the hashing module 120 may monotonically increase the 1-byte counter 508 value by 1-bit for an iteration. For example, the monotonical increase of the 1-byte counter 508 value may salt the input message. If the 1-byte counter 508 does not exist in the input message 504, then the hashing module 518 can continue to a next hash computation execution 520. In this way, at least a portion of the digest message of a given iteration may be loaded directly back into a configurable position in the input buffer 502, updating the input message for a next hash computation (“repeated hash computation”). In so doing, this method of iterative hash computation bypasses memory copies and bus latencies, accelerating quantum-resistant, cryptographic hash-based signature computations.

### System-on-Chip

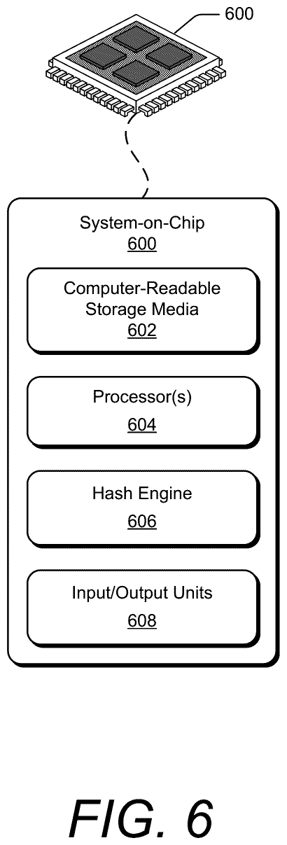

FIG. 6 illustrates an integrated circuit component (e.g., integrated circuit component 126) implemented as an SoC 600 that can implement various aspects of accelerating iterative hash computations. The SoC 600 may be a single chip including components that are fabricated on a same semiconductor substrate. Alternatively, the SoC may be a number of such chips that are epoxied together. The SoC 600 can be implemented in any suitable device, such as a smartphone, cellular phone, netbook, tablet computer, server, wireless router, network-attached storage, camera, smart appliance, printer, a set-top box, or any other suitable type of device. Although described with reference to a SoC, the entities of FIG. 6 may also be implemented as an ASIC, a field-programmable gate array (FPGA), or the like.

The SoC 600 can be integrated with electronic circuitry, including the components described in the operating system listed herein. The SoC 600 can also include an integrated data bus (not shown) that couples the various components of the SoC for data communication between the components. The integrated data bus or other components of the SoC 600 may be exposed or accessed through an external port, such as a JTAG port. For example, components of the SoC 600 may be tested, configured, or programmed (e.g., flashed) through the external port at different stages of manufacture.

In this example, the SoC 600 includes computer-readable storage media 602, one or more processor(s) 604, a hash engine 606, and I/O units 608. The computer-readable storage media 602 may include one or more non-transitory storage devices such as a RAM ((DRAM, NVRAM, or SRAM), ROM, or flash memory), hard drive, SSD, or any type of media suitable for storing electronic instructions, each coupled with a computer system bus. The computer-readable storage media 602 may include all, or some, instructions of a hash manager (e.g., hash manager 114). The processor(s) 604 may implement instructions of the hash manager. In some implementations, any secure, root of trust (RoT) component may be implemented as the hash engine 604, including a cryptographic processor. Further, the hash engine 604 may implement any cryptographic hash function, such as SHA256.

Although the subject matter has been described in language specific to structural features and/or methodological operations, it is to be understood that the subject matter defined in the appended claims is not necessarily limited to the specific features or operations described herein, including orders in which they are performed.

### EXAMPLES

In the following section, examples are provided.

Example 1: A computer-implemented method comprising: loading a first input message into an input buffer; computing, by a hash engine and using the first input message as input, a hash computation, the hash computation resulting in a digest message; loading at least a portion of the digest message directly to a configurable position in the input buffer; and repeating the hash computation for a predetermined number of iterations, each of the repeated hash computations resulting in at least a portion of a digest message loaded directly into a configurable position in the input buffer for use as input to be used by a later iteration of the repeated hash computation.

Example 2: The computer-implemented method as recited in example 1, wherein the hash engine is a cryptographic processor implementing a cryptographic hash function.

Example 3: The computer-implemented method as recited in example 1, wherein the digest message is 32 bytes in length.

Example 4: The computer-implemented method as recited in example 1, wherein the input buffer is a register file of the hash engine.

Example 5: The computer-implemented method as recited in example 1, wherein loading at least a portion of the digest message directly into the configurable position in the input buffer is implemented without loading the digest message to memory external to the hash engine.

Example 6: The computer-implemented method as recited in example 1, wherein the first input message is a bit-string including a concatenation of a prefix, a counter, and a secret seed.

Example 7: The computer-implemented method as recited in example 5, wherein the first input message is 56 bytes in length.

Example 8: The computer-implemented method as recited in example 1, wherein loading at least a portion of the digest message directly into a configurable position in the input buffer replaces a secret seed.

Example 9: The computer-implemented method as recited in example 1, wherein the repeating the hash computation executes as many as 256 times.

Example 10: The computer-implemented method as recited in example 1 further comprising: decrementing an iteration counter; and incrementing a 1-byte counter if an input message to the repeated hash computation includes a 1-byte counter.

Example 11: The computer-implemented method as recited in example 10, wherein the iteration counter is assigned a value in a range of 0 to 255 at initialization.

Example 12: The computer-implemented method as recited in example 11, wherein the iteration counter is loaded into a register of the hash engine.

Example 13: The computer-implemented method as recited in example 10, wherein the 1-byte counter starts at a value configured for hash-based signature verification.

Example 14: The computer-implemented method as recited in example 13, wherein the 1-byte counter monotonically increases.

Example 15: A computing device comprising: at least one processor; and at least one computer-readable storage medium comprising instructions that, when executed by the at least one processor, cause the processor to perform the method of any preceding example.

### CONCLUSION

Although implementations of techniques for, and apparatuses enabling, accelerating quantum-resistant, cryptographic hash-based signature computations have been described in language specific to features and/or methods, it is to be understood that the subject of the appended claims is not necessarily limited to the specific features or methods described. Rather, the specific features and methods are disclosed as example implementations enabling the acceleration of quantum-resistant, cryptographic hash-based signature computations.

1. A computer-implemented method comprising:
loading a first input message into an input buffer;
computing, by a hash engine and using the first input message as an input, a hash computation, the hash computation resulting in a digest message;
loading at least a portion of the digest message directly to a configurable position in the input buffer; and
repeating the hash computation for a predetermined number of iterations, each of the repeated hash computations resulting in at least a portion of a digest message loaded directly into said configurable position in the input buffer for use as input to be used by a later iteration of the repeated hash computation.

2. The computer-implemented method as recited in claim 1, wherein the hash engine is a cryptographic processor implementing a cryptographic hash function.

3. The computer-implemented method as recited in claim 1, wherein the digest message is 32 bytes in length.

4. The computer-implemented method as recited in claim 1, wherein the input buffer is a register file of the hash engine.

5. The computer-implemented method as recited in claim 1, wherein loading at least a portion of the digest message directly into the configurable position in the input buffer is implemented without loading the digest message to memory external to the hash engine.

6. The computer-implemented method as recited in claim 1, wherein the first input message is a bit-string including a concatenation of a prefix, a counter, and a secret seed.

7. The computer-implemented method as recited in claim 6, wherein the first input message is 56 bytes in length.

8. The computer-implemented method as recited in claim 1, wherein the first input message comprises a secret seed loaded into said configurable position in the input buffer, and loading at least a portion of the digest message directly into the configurable position in the input buffer replaces the secret seed.

9. The computer-implemented method as recited in claim 1, wherein the repeating the hash computation executes as many as 256 times.

10. The computer-implemented method as recited in claim 1 further comprising:
decrementing an iteration counter; and
incrementing a 1-byte counter if an input message to the repeated hash computation includes a 1-byte counter.

11. The computer-implemented method as recited in claim 10,
wherein the iteration counter is assigned a value in a range of 0 to 255 at initialization.

12. The computer-implemented method as recited in claim 11, wherein the iteration counter is loaded into a register of the hash engine.

13. The computer-implemented method as recited in claim 10, wherein the 1-byte counter starts at a value configured for hash-based signature verification.

14. The computer-implemented method as recited in claim 13, wherein the 1-byte counter monotonically increases.

15. (canceled)

16. An integrated circuit comprising:
an input buffer with a configurable position input;
a hash engine configured to compute hash values; and
a hash manager configured to:
load a first input message into the input buffer;
compute, with the hash engine and using the first input message as an input, a hash computation, the hash computation resulting in a digest message;
load at least a portion of the digest message directly to the configurable position in the input buffer; and
repeating the hash computation for a predetermined number of iterations, each of the repeated hash computations resulting in at least a portion of a digest message loaded directly into the configurable position in the input buffer for use as input to be used by a later iteration of the repeated hash computation.

17. The integrated circuit as recited in claim 16, wherein the input buffer is a register file of the hash engine.

18. The integrated circuit as recited in claim 16, wherein to load the at least a portion of the digest message directly into the configurable position in the input buffer is implemented without loading the digest message to memory external to the hash engine.

19. The integrated circuit as recited in claim 16, wherein the first input message comprises a bit-string including a concatenation of a prefix, a counter, and a secret seed.

20. The integrated circuit as recited in claim 19, wherein the first input message is 56 bytes in length.

21. The integrated circuit as recited in claim 16, wherein the first input message comprises a secret seed loaded into the configurable position in the input buffer, and the at least a portion of the digest message loaded directly into the configurable position in the input buffer replaces the secret seed.
